(19) United States
(12) Patent Application Publication
(10) Pub. No.: US 2023/0202682 A1
(43) Pub. Date: Jun. 29, 2023

(54) VEHICLE TOP STRUCTURE

(71) Applicant: TOYOTA JIDOSHA KABUSHIKI KAISHA, Toyota-shi Aichi-ken (JP)

(72) Inventors: Hiroaki Kiyokami, Nisshin-shi Aichi-ken (JP); Masao Tajima, Toyota-shi Aichi-ken (JP)

(73) Assignee: TOYOTA JIDOSHA KABUSHIKI KAISHA, Toyota-shi Aichi-ken (JP)

(21) Appl. No.: 18/085,000

(22) Filed: Dec. 20, 2022

(30) Foreign Application Priority Data
Dec. 24, 2021 (JP) 2021-211077

(51) Int. Cl. B64F 1/22; B60J 11/06; B64C 39/02; B64U 70/90; B64U 80/80

(52) U.S. Cl. CPC B64F 1/22; B60J 11/06; B64C 39/024; B64U 70/90; B64U 80/80; B60W 60/00

(57) ABSTRACT

A vehicle includes, on its roof, a first autonomous driving sensor, a second autonomous driving sensor, and a takeoff and landing assist device. The first autonomous driving sensor is disposed adjacent to the front of the vehicle for sensing conditions ahead of the vehicle. The second autonomous driving sensor is disposed adjacent to the rear of the vehicle for sensing conditions behind the vehicle. The takeoff and landing assist device includes a takeoff and landing surface where a flying device takes off and lands. The takeoff and landing assist device is disposed between the first autonomous driving sensor and the second autonomous driving sensor.

### CROSS REFERENCE TO RELATED APPLICATION

This application claims priority to Japanese Patent Application No. 2021-211077 filed on Dec. 24, 2021, which is incorporated herein by reference in its entirety including the specification, claims, drawings, and abstract.

### TECHNICAL FIELD

The present disclosure relates to a vehicle top structure including a takeoff and landing assist device for takeoff and landing of a flying device.

### BACKGROUND

Flying devices such as drones or unmanned aerial vehicles (UAVs) are known. Some vehicles may include, on the top of the vehicle, a takeoff and landing assist device having a platform where a flying device takes off and lands.

JP 2018-165205 A discloses a takeoff and landing section disposed on the roof of a vehicle to allow taking off and landing of a flying device.

Autonomous vehicles may include a sensor for autonomous driving (hereinafter referred to as an “autonomous driving sensor”) on the top of the vehicle. In these vehicles, a takeoff and landing assist device disposed further forward of the vehicle with respect to the autonomous driving sensor may interfere with sensing performed by the autonomous driving sensor.

An aspect of the disclosure is therefore aimed at enabling taking off and landing of a flying device without interference with sensing performed by an autonomous driving sensor in a vehicle including, on its top, an autonomous driving sensor and a platform where the flying device takes off and lands.

### SUMMARY

In accordance with an aspect of the disclosure, a vehicle top structure includes: a takeoff and landing assist device disposed on a top of a vehicle and including a takeoff and landing surface where a flying device takes off and lands; a first autonomous driving sensor disposed further forward of the vehicle on the top of the vehicle with respect to the takeoff and landing assist device and configured to sense conditions ahead of the vehicle; and a second autonomous driving sensor disposed further rearward of the vehicle on the top of the vehicle with respect to the takeoff and landing assist device and configured to sense conditions behind the vehicle.

The above configuration includes a first autonomous driving sensor adjacent to the front of the vehicle, a second autonomous driving sensor adjacent to the rear of the vehicle, and a takeoff and landing assist device between the first autonomous driving sensor and the second autonomous driving sensor. This configuration prevents the takeoff and landing assist device from interfering with sensing of conditions ahead of the vehicle by the first autonomous driving sensor and sensing of conditions behind the vehicle by the second autonomous driving sensor. This configuration therefore enables simultaneous establishment of sensing by the autonomous driving sensors and assistance for taking off and landing of the flying device by the takeoff and landing assist device.

The top surface of the first autonomous driving sensor and the top surface of the second autonomous driving sensor may be disposed at a lower level of the vehicle than the takeoff and landing surface.

In the above configuration, the top surface of the first autonomous driving sensor and the top surface of the second autonomous driving sensor are disposed at a lower level of the vehicle than the takeoff and landing surface. This configuration can prevent the first autonomous driving sensor and the second autonomous driving sensor from obstructing takeoff or landing of the flying device from and on the takeoff and landing surface.

The vehicle top structure may further include a cover disposed on the first autonomous driving sensor to shield the flying device when landed on the takeoff and landing surface.

The above configuration includes a cover to reduce the air resistance during traveling of the vehicle, thereby increasing the fuel efficiency.

The disclosure enables taking off and landing of a flying device without interfering with sensing by autonomous driving sensors in a vehicle that includes, on its top, a takeoff and landing assist device having a platform where the flying device takes off or lands, and the autonomous driving sensors.

### BRIEF DESCRIPTION OF DRAWINGS

Embodiments of the disclosure will be described by reference to the following figures, wherein:

FIG. 1 is a perspective view of a vehicle including a takeoff and landing assist device and sensors for autonomous driving;

FIG. 2 is a left side view of the vehicle;

FIG. 3 is a plan view of the vehicle seen from above;

FIG. 4 is a left side view of a vehicle including a base on the roof according to another embodiment;

FIG. 5 is a perspective view of a vehicle having a cover on a first autonomous driving sensor;

FIG. 6 is a left side view of a vehicle including a cover to cover a flying device on a first autonomous driving sensor;

FIG. 7 is a left side view of the vehicle with part of the cover being removed;

FIG. 8 is a left side view of a vehicle with a cover according to another embodiment;

FIG. 9 is a left side view of a vehicle, illustrating the cover in FIG. 8 starting to open;

FIG. 10 is a left side view of a vehicle, illustrating the cover in FIG. 9 being opened;

FIG. 11 is a left side view of a vehicle including autonomous driving sensors stored within a roof;

FIG. 12 is a perspective view illustrating a takeoff and landing assist device and a flying device;

FIG. 13 is a plan view of the takeoff and landing assist device seen from above;

FIG. 14 is an exploded perspective view of a takeoff and landing assist device;

FIG. 15 is a perspective view illustrating a takeoff and landing assist device with a flying device having landed thereon;

FIG. 16 is a perspective view illustrating a takeoff and landing assist device with a flying device being secured thereto;

FIG. 17 is a perspective view illustrating a flying device and a takeoff and landing assist device at the time of takeoff; and

FIG. 18 is a perspective view illustrating a flying device and a takeoff and landing assist device at the time of takeoff.

### DESCRIPTION OF EMBODIMENTS

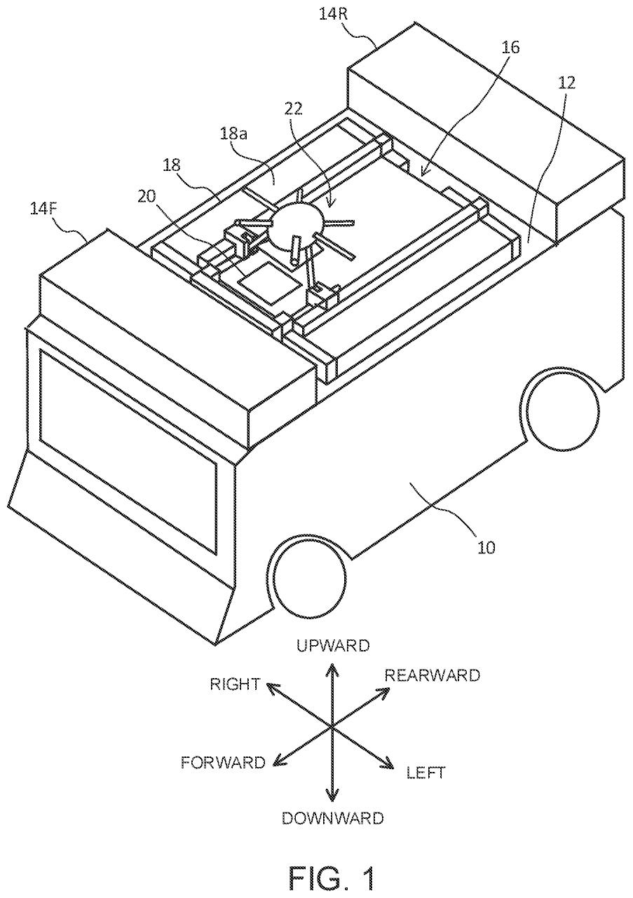

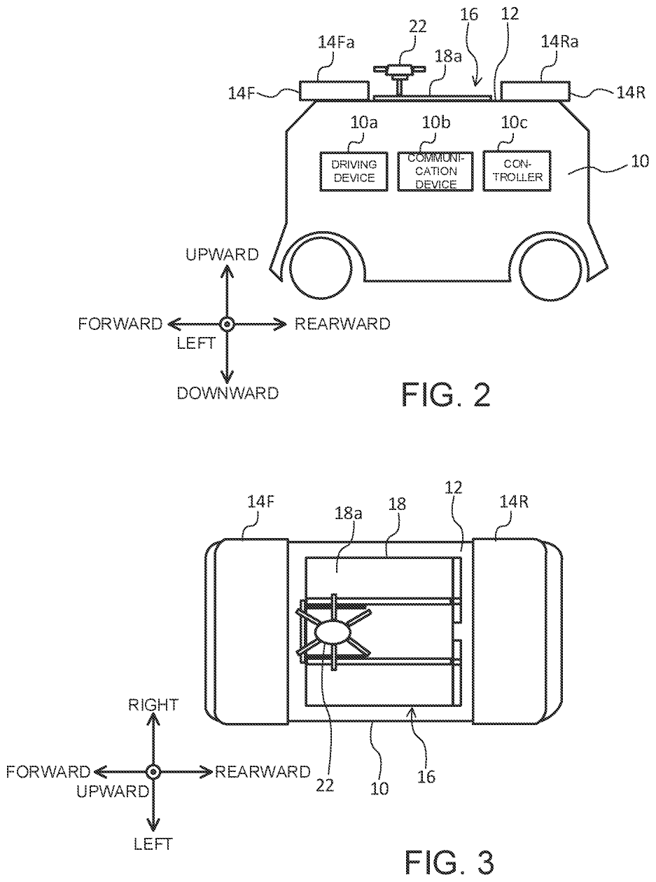

Referring to FIG. 1, FIG. 2, and FIG. 3, a vehicle top structure according to an embodiment will be described. FIG. 1 is a perspective view illustrating a vehicle. FIG. 2 is a side view of the vehicle seen from the left, and FIG. 3 is a plan view of the vehicle seen from above.

A vehicle 10 is an automotive vehicle capable of autonomous driving. Autonomous driving refers to driving of a vehicle automatically, including steering, accelerating, and decelerating of a vehicle without operation performed by a driver or other human. Autonomous driving according to the embodiment may include conditional driving automation in which steering, accelerating, and decelerating of a vehicle is performed without human operation under a specific condition and steering, accelerating, and decelerating of a vehicle is performed with human operation when the specific condition is not satisfied, or full driving automation in which steering, accelerating, and decelerating of a vehicle is performed completely without human operation. The vehicle 10, in an autonomous driving mode, travels autonomously while monitoring the surroundings of the vehicle 10.

The vehicle 10 includes a driving device 10a, a communication device 10b, and a controller 10c. The driving device 10a is a device that enables the vehicle 10 to travel, and includes a motor, a power transmission device, a brake system, a travel gear, a suspension system, and a steering system, for example.

The communication device 10b performs wireless communication. For example the communication device 10b communicates with a local operation management center that performs operation management of local autonomous vehicles, vehicles travelling nearby, and various beacons embedded in roads. The communication device 10b may transmit and receive information through the Internet.

The controller 10c controls driving of the driving device 10a to drive the vehicle 10 to travel. The controller 10c is a computer including a processor and a memory, for example.

To enable autonomous driving, the vehicle 10 includes various sensors. The vehicle 10 includes, for example, on its top or upper portion, a first autonomous driving sensor 14F and a second autonomous driving sensor 14R. The top of the vehicle 10 may be a location on a roof 12 of the vehicle 10 or a location within the roof 12 having a certain thickness. In the example illustrated in FIG. 1, the first autonomous driving sensor 14F and the second autonomous driving sensor 14R are disposed on the roof 12 of the vehicle 10.

The first autonomous driving sensor 14F is disposed adjacent to the front of the vehicle 10 on the roof 12 for sensing conditions ahead of the vehicle 10. The second autonomous driving sensor 14R is disposed adjacent to the rear of the vehicle 10 on the roof 12 for sensing conditions behind the vehicle 10.

The first autonomous driving sensor 14F and the second autonomous driving sensor 14R detect the environment around the vehicle 10, and may include, for example, a camera, a Lidar, a millimeter-wave radar, a sonar, and a magnetic sensor. The vehicle 10 further includes a Global Navigation Satellite System (GNSS) such as Global Positioning System (GPS), or a gyroscope sensor, for example.

The controller 10c controls driving of the driving device 10a, based on information acquired by various sensors including the first autonomous driving sensor 14F and the second autonomous driving sensor 14R and information received by the communication device 10b, to enable the vehicle 10 to travel. The controller 10c, for example, controls driving of the driving device 10a based on the conditions ahead of the vehicle 10, such as presence of other vehicles, persons, and obstacles, acquired by the first autonomous driving sensor 14F, and the conditions behind the vehicle 10, such as presence of other vehicles, persons, and obstacles, acquired by the second autonomous driving sensor 14R, thereby controlling travelling of the vehicle 10.

The vehicle 10 further includes a takeoff and landing assist device 16 on the roof 12 of the vehicle 10. The takeoff and landing assist device 16 assists taking off and landing of a flying device 22.

The flying device 22 is a drone or an unmanned aerial vehicle, for example. The flying device 22 may be a known drone or a known unmanned aerial vehicle, for example. When a drone is used as the flying device 22, the takeoff and landing assist device 16 may be referred to as a drone port. In the takeoff and landing assist device 16, loading and unloading of cargo using the flying device 22, electric supply to the flying device 22, parts replacement of the flying device 22, and storage of the flying device 22, for example, are performed.

The takeoff and landing assist device 16 includes a platform 18. The platform 18 is a member entirely having a rectangular shape where the flying device 22 takes off and lands. The platform 18 has a planar takeoff and landing surface 18a on which the flying device 22 lands and from which the flying device 22 takes off.

The takeoff and landing assist device 16 further includes a fixing device for the flying device 22. The fixing device secures the flying device 22 to the takeoff and landing surface 18a. Any devices may be used as the fixing device. The fixing device may, for example, hold, press, or engage legs of the flying device 22 to thereby mechanically secure the flying device 22 to the takeoff and landing surface 18a. The fixing device may mechanically secure the flying device 22 with a fastener or may fix the flying device 22 with a magnetic force of a magnet such as an electromagnet.

The platform 18 includes an opening 20. The opening 20 is disposed at a position corresponding to the flying device 22 fixed on the takeoff and landing surface 18a. For example, a cargo loaded on the flying device 22 is transported to the takeoff and landing assist device 16 through the opening 20, and a cargo is loaded on the flying device 22 through the opening 20. The opening 20 has an openable lid, which opens for loading and unloading and is closed at other times. The lid is opened or closed by a motor, for example, under the control of a controller, such as a controller 100, which will be described below.

The takeoff and landing assist device 16 is disposed on the roof 12, between the first autonomous driving sensor 14F and the second autonomous driving sensor 14R.

The takeoff and landing assist device 16 therefore does not interfere with forward sensing of the vehicle 10 by the first autonomous driving sensor 14F or rearward sensing of the vehicle by the second autonomous driving sensor 14R. This enables simultaneous establishment of both sensing by the autonomous driving sensors and takeoff and landing of the flying device 22 by the takeoff and landing assist device 16. More specifically, the vehicle 10 having the first autonomous driving sensor 14F, the second autonomous driving sensor 14R, and the takeoff and landing assist device 16 on the roof 12 enables the forward sensing by the first autonomous driving sensor 14F and the rearward sensing by the second autonomous driving sensor 14R and also enables takeoff and landing of the flying device 22 on the roof 12.

The vehicle 10 having a relatively long entire length, for example, may include the first autonomous driving sensor 14F and the second autonomous driving sensor 14R separately for forward sensing and rearward sensing, respectively, to thereby detect the surroundings of the vehicle 10. In this configuration, the takeoff and landing assist device 16 disposed between the first autonomous driving sensor 14F and the second autonomous driving sensor 14R enables takeoff and landing of the flying device 22 without interfering with the sensing performed by the autonomous driving sensors. However, the first autonomous driving sensor 14F and the second autonomous driving sensor 14R may be disposed separately irrespective of the length of the vehicle 10 in the longitudinal direction.

As illustrated in FIG. 2, the first autonomous driving sensor 14F and the second autonomous driving sensor 14R have a top surface 14Fa and a top surface 14Ra, respectively, which are located at a higher level than the takeoff and landing surface 18a. In other words, the takeoff and landing surface 18a is disposed at a lower level of the vehicle 10 than the top surfaces 14Fa and 14Ra. The top surface 14Fa refers to an upper surface of the first autonomous driving sensor 14F, and the top surface 14Ra refers to an upper surface of the second autonomous driving sensor 14R.

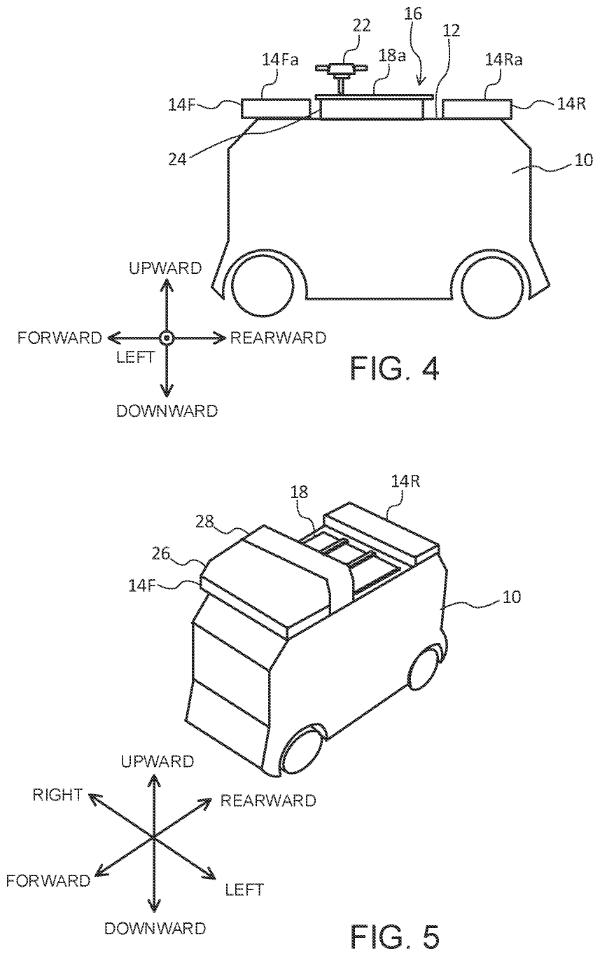

FIG. 4 illustrates another embodiment. FIG. 4 is a left side view of the vehicle 10. In the example illustrated in FIG. 4, the top surface 14Fa of the first autonomous driving sensor 14F and the top surface 14Ra of the second autonomous driving sensor 14R are disposed at a lower level than the takeoff and landing surface 18a. In other words, the takeoff and landing surface 18a is disposed at a higher level of the vehicle 10 than the top surfaces 14Fa and 14Ra, that is at a higher position than the top surfaces 14Fa and 14Ra.

For example, a base 24 is disposed on the roof 12 between the first autonomous driving sensor 14F and the second autonomous driving sensor 14R, and the takeoff and landing assist device 16 is disposed on the base 24. The height, or the thickness in the vertical direction, of the base 24 is set such that the takeoff and landing surface 18a is disposed at a higher level of the vehicle 10 than the top surfaces 14Fa and 14Ra.

The configuration including the takeoff and landing surface 18a disposed at a higher level of the vehicle 10 than the top surfaces 14Fa and 14Ra as described above avoids obstruction of taking off of the flying device 22 from the takeoff and landings surface 18a or landing of the flying device 22 on the takeoff and landing surface 18a, by the autonomous driving sensor 14F and the second autonomous driving sensor 14R. For example, it is possible to prevent the first autonomous driving sensor 14F and the second autonomous driving sensor 14R from obstructing the flow of air currents generated by the flying device 22 at the time of takeoff or landing. Further, risk of collision of the flying device 22 with the first autonomous driving sensor 14F or the second autonomous driving sensor 14R during takeoff and landing can be reduced.

The base 24 may be an elevator and the height of the base 24 may be adjustable. For example, the base 24 may be electrically driven to ascend or descent, with the height of the base 24 being adjustable with a controller (such as a controller 100 which will be described below) mounted on the vehicle 10.

At the time of a takeoff or landing, the base 24 is lifted to thereby dispose the takeoff and landing surface 18a at a higher level of the vehicle 10 than the top surfaces 14Fa and 14Ra. This prevents either the first autonomous driving sensor 14F or the second autonomous driving sensor 14R from obstructing taking off or landing of the flying device 22. At times other than takeoff or landing, the base 24 is lowered to dispose the takeoff and landing surface 18a at a lower level of the vehicle 10 than the top surfaces 14Fa and 14Ra, thereby reducing wind resistance from the takeoff and landing assist device 16.

The base 24 may be lifted or lowered manually, and the height of the base 24 may be adjusted by a human, such as a driver.

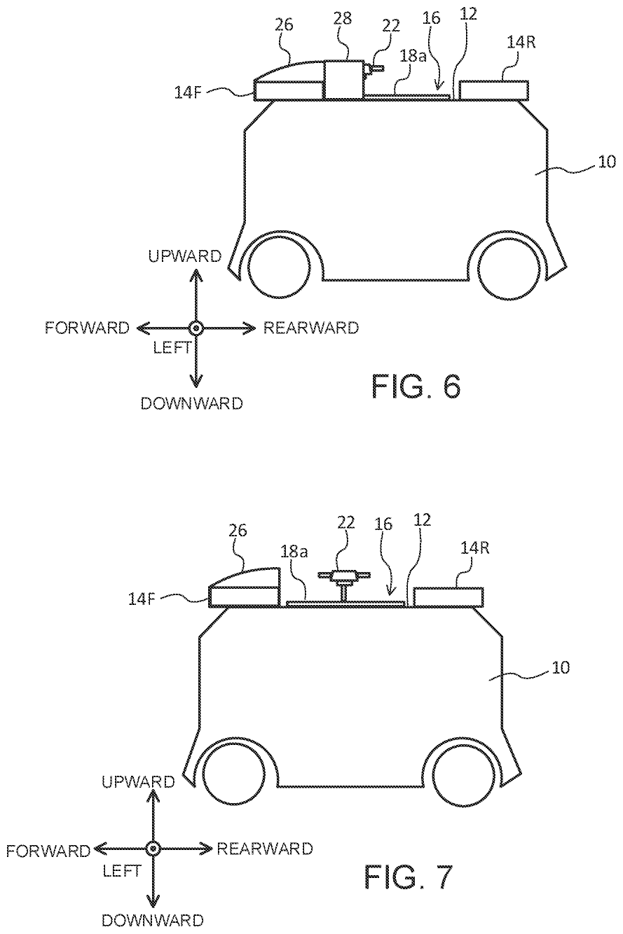

A cover may be disposed on the roof 12 to shield the flying device 22 that has landed on the takeoff and landing surface 18a. The cover will be described by reference to FIGS. 5 to 7, of which FIG. 5 is a perspective view illustrating the vehicle 10 with a cover, and FIGS. 6 and 7 are left side view of the vehicle 10 with a cover.

As illustrated in FIG. 5 and FIG. 6, covers 26 and 28 are disposed on the roof 12. The covers 26 and 28 are secured on the roof 12 with a fastener or a magnetic force of a magnet, for example. The covers 26 and 28 may be an integral member or separate members.

The cover 26 is disposed on the top surface 14Fa of the first autonomous driving sensor 14F to shield the top surface 14Fa. The height of the cover 26 is greater than the height of the flying device 22 landing on the takeoff and landing surface 18a such that the flying device 22 is shielded with the cover 26 when viewed from the front of the vehicle 10. The cover 26 has a top surface having a curved shape, such as a streamlined shape, from the front toward the rear of the vehicle 10, for example.

The cover 28 shields the flying device 22 landing on the takeoff and landing surface 18a. In the illustrated example, the flying device 22 is fixed adjacent to the first autonomous driving sensor 14F on the takeoff and landing surface 18a, and the cover 28 shields the flying device 22 at the position where the flying device 22 is secured.

To enable the flying device 22 to take off from the takeoff and landing surface 18a, the cover 28 is removed from the roof 12, as illustrated in FIG. 7. In the illustrated example, the covers 26 and 28 are separate members, of which only the cover 28 is removed manually, for example. With the cover 28 being removed from the vehicle 10, the flying device 22 takes off from the takeoff and landing surface 18a. The flying device 22 is first moved to a center of the takeoff and landing surface 18a or near the center before taking off.

The removed cover 28 may be stored within the vehicle 10 or may be folded and stored within a cavity inside the cover 26.

The cover 26 reduces the effect of air currents generated during travelling of the vehicle 10. The cover 28 furthers protects the flying device 22 from the sunlight and rain, for example.

Of the covers 26 and 28, it is possible, for example, to mount only the cover 26 on the first autonomous driving sensor 14 on the roof 12, without the cover 28. Without any cover, when the flying device 22 lands on the takeoff and landing surface 18a while the vehicle 10 is travelling forward, an air current flowing from the front toward the rear of the vehicle 10 may impact the flying device 22 and generate air resistance. The cover 26 disposed further forward of the vehicle 10 with respect to the flying device 22 for shielding the flying device 22, however, shields the flying device 22 from the air current, thereby reducing the air resistance. More specifically, the impact of air resistance on the flying device 22 is reduced by directing the air current along the top surface of the cover 26 above the flying device 22 toward the rear of the vehicle 10 such that it does not directly impact the flying device 22. This also increases fuel efficiency.

Further, to protect the flying device 22 from sunlight and rain, for example, the cover 28 that shields the flying device 22 is disposed on the roof 12. The cover 28 may be mounted on the roof 12 not only while the vehicle 10 is stopped, but also during travelling of the vehicle 10.

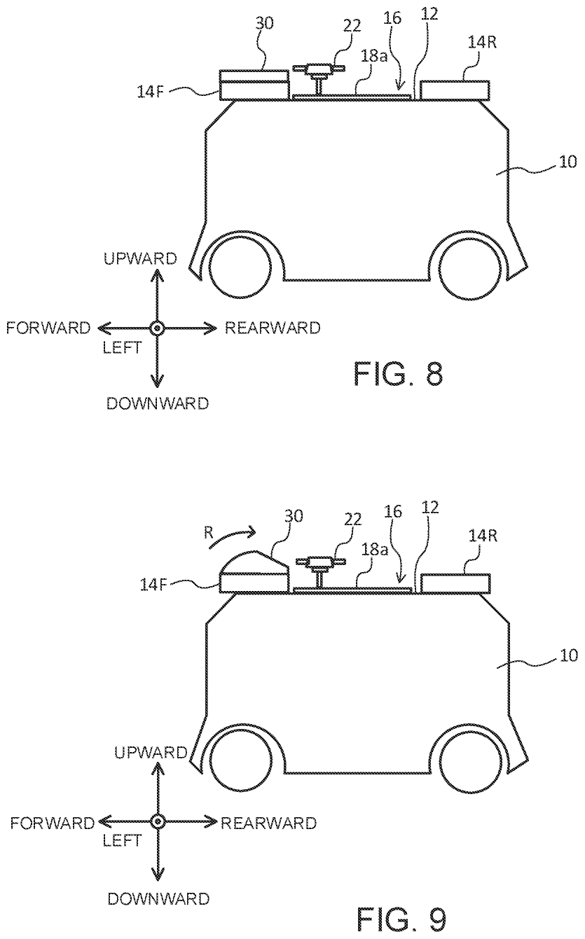

FIGS. 8, 9, and 10 illustrate another embodiment of the cover. FIGS. 8, 9, and 10 are left side views of the vehicle 10 with another cover being disposed.

In this embodiment, a foldable cover 30 is used. As illustrated in FIG. 8, the cover 30, in its folded state, is disposed on the top surface 14Fa of the first autonomous driving sensor 14. To shield the flying device 22 with the cover 30, the cover 30 is manually or automatically expanded rearward as indicated by arrow R in FIG. 9.

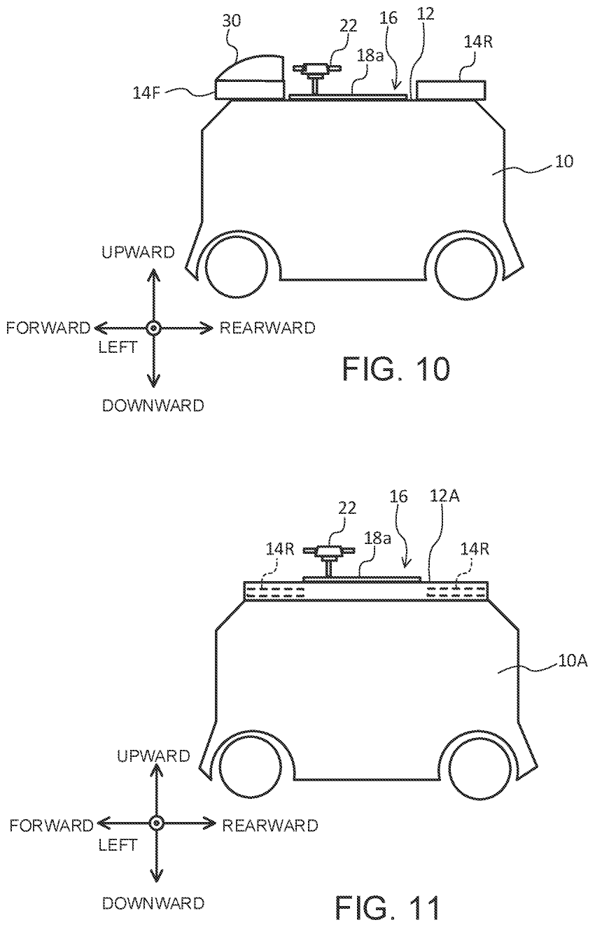

FIG. 10 illustrates the cover 30 completely expanded rearward. The fully expanded cover 30 shields the front of the flying device 22. In order to allow the cover 30 to shield the front of the flying device 22, the cover 30 is expanded rearward prior to travelling.

The cover 30 may be expanded further rearward of the vehicle 10 in order to cover the top of the flying device 22. This enables the cover 30 to have the same function as the cover 28. To enable the flying device 22 to take off, the cover 30 is folded forward of the vehicle 10, thereby opening the top of the flying device 22 secured to the takeoff and landing surface 18a.

Referring now to FIG. 11, a vehicle 10A according to a modification example will be described. FIG. 11 is a left side view of the vehicle 10A.

The vehicle 10A includes a roof 12A that is a hollow member having a cavity within the member. The roof 12A has a thickness to allow the autonomous driving sensor 14F and the second autonomous driving sensor 14R to be stored in an inner space. The first autonomous driving sensor 14F and the second autonomous driving sensor 14R are stored in the space within the roof 12A. The takeoff and landing assist device 16 is disposed on the roof 12A.

In the configuration in which the first autonomous driving sensor 14F and the second autonomous driving sensor 14R are stored within the roof 12A as described above, similarly as in the configuration in the embodiment described above, the takeoff and landing assist device 16 does not interfere with sensing performed by the first autonomous driving sensor 14F and the second autonomous driving sensor 14R. This configuration can therefore enable both sensing by the autonomous driving sensors and takeoff and landing of the flying device 22 by the takeoff and landing assist device 16.

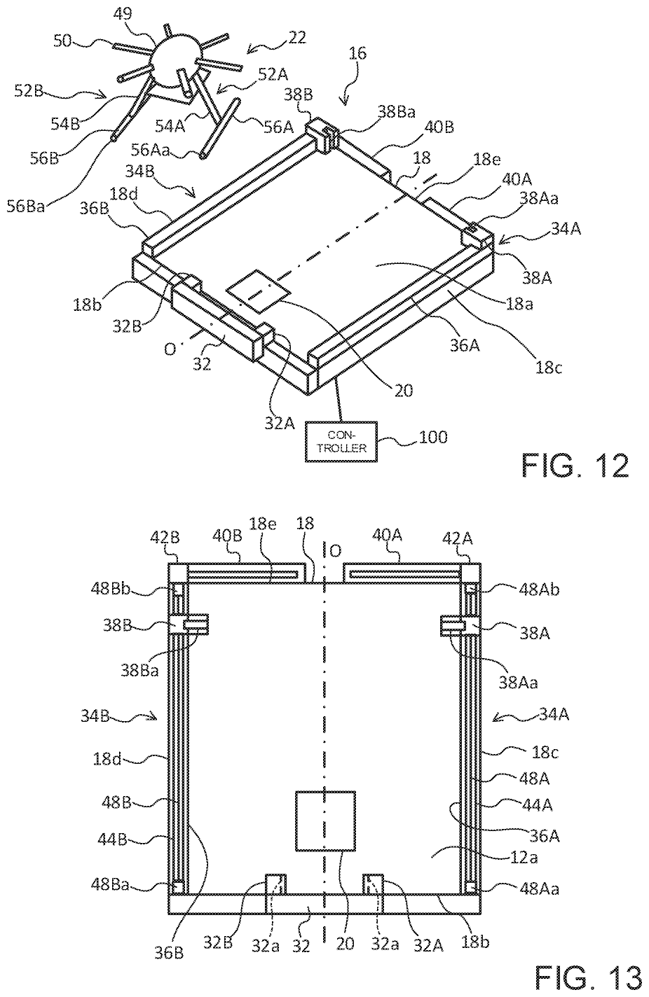

Referring now to FIG. 12 to FIG. 14, the configuration of the takeoff and landing assist device 16 will be described. The configuration of the takeoff and landing assist device 16 which will be described below is only an example, and takeoff and landing assist devices having other configurations may be disposed on the roof 12.

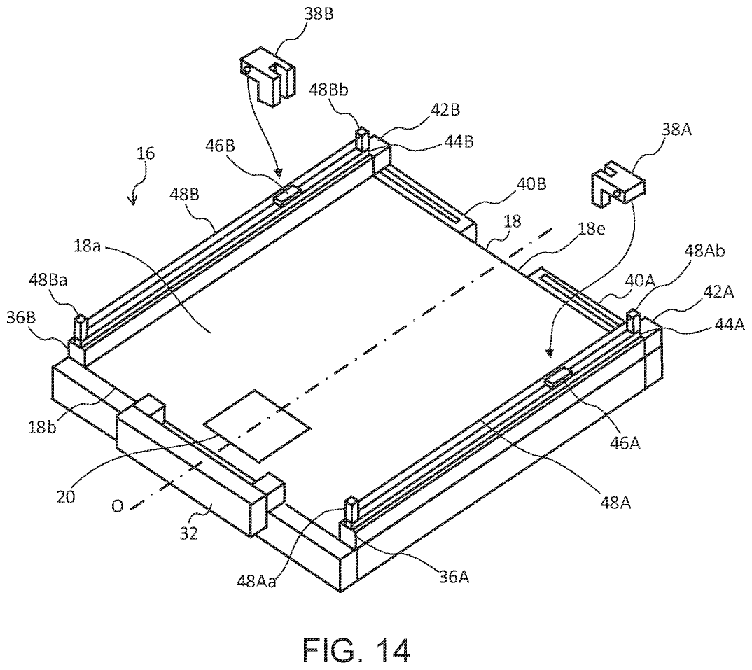

FIG. 12 is a perspective view illustrating the takeoff and landing assist device 16 and the flying device 22, and FIG. 13 is a plan view of the takeoff and landing assist device 16. FIG. 14 is an exploded perspective view of the takeoff and landing assist device 16.

The takeoff and landing assist device 16 includes the platform 18, a retainer 32, moving mechanisms 34A and 34B, and a controller 100.

The platform 18 has an overall rectangular shape, and includes the takeoff and landing surface 18a, and edges 18b, 18c, 18d, and 18e. The edge 18b and the edge 18e face each other and the edge 18c and the edge 18d face each other. A line connecting the center of the edge 18b and the center of the edge 18e is defined as a center line O of the platform 18.

The retainer 32 is disposed on the edge 18b of the platform 18, and receives the legs of the flying device 22 to be inserted in the retainer 32. The retainer 32 is disposed on the edge 18b, at or near the center between the edge 18c and the edge 18d.

The retainer 32 includes receiving portions 32A and 32B disposed along the edge 18b at an interval about the center line O. The receiving portion 32A is disposed closer to the edge 18c with respect to the center line O, and the receiving portion 32B is disposed closer to the edge 18d with respect to the center line O. Each of the receiving portions 32A and 32B is open at a surface facing the edge 18e, and each of the receiving portions 32A and 32B includes an insertion hole 32a. The retainer 32 thus has insertion holes 32a at two locations, into which the legs of the flying device 22 are to be inserted.

The takeoff and landing assist device 16 is disposed on the roof 12 of the vehicle 10 while adjusting the position of the takeoff and landing assist device 16 on the roof 12 such that the retainer 32 is located closer to the first autonomous driving sensor 14F than to the second autonomous driving sensor 14R. This configuration allows the flying device 22 having legs inserted into the insertion holes 32a, to be secured closer to the first autonomous driving sensor 14F on the takeoff and landing surface 18a. The cover 26 disposed on the top surface 14Fa of the first autonomous driving sensor 14F in this state would shield the flying device 22.

The moving mechanisms 34A and 34B move the flying device 22 on the platform 18. The moving mechanisms 34A and 34B, for example, move the flying device 22 that has landed on the platform 18 within the edges 18b, 18c, 18d, and 18e to the retainer 32, to allow the legs of the flying device 22 to be inserted into the insertion holes 32a.

The moving mechanism 34A includes a position correcting mechanism 36A and a gripping mechanism 38A. The moving mechanism 34B includes a position correcting mechanism 36B and a gripping mechanism 38B.

The position correcting mechanisms 36A and 36B are rod-like members extending from the edge 18b to the edge 18e on the platform 18 and are opposed to each other on the takeoff and landing surface 18a.

The position correcting mechanism 36A is disposed in a region on the takeoff and landing surface 18a closer to the edge 18c with respect to the center line O. The position correcting mechanism 36A is moved by an electric actuator 40A between the edge 18c and the center line O. The position correcting mechanism 36A is slidable between the edge 18c and the center line O, for example.

The electric actuator 40A is disposed along the edge 18e closer to the edge 18c with respect to the center line O. As illustrated in FIG. 13 and FIG. 14, the electric actuator 40A includes a slider 42A that is movable by the electric actuator 40A between the center line O and the edge 18c along the edge 18e. One end of the position correcting mechanism 36A adjacent to the edge 18e is connected with the slider 42A. The slider 42A is moved by the electric actuator 40A along the edge 18e to thereby move the position correcting mechanism 36A coupled to the slider 42A.

The position correcting mechanism 36B is disposed in a region on the takeoff and landing surface 18a closer to the edge 18d with respect to the center line O. The position correcting mechanism 36B is moved by an electric actuator 40B between the edge 18d and the center line O. The position correcting mechanism 36B is slidable between the edge 18d and the center line O, for example.

The electric actuator 40B is disposed along the edge 18e closer to the edge 18d with respect to the center line O. As illustrated in FIG. 13 and FIG. 14, the electric actuator 40B includes a slider 42B that is movable by the electric actuator 40B between the center line O and the edge 18d along the edge 18e. One end of the position correcting mechanism 36B adjacent to the edge 18e is connected with the slider 42B. The slider 42B is moved by the electric actuator 40B along the edge 18e to thereby move the position correcting mechanism 36B coupled to the slider 42B.

The gripping mechanism 38A is movable by an electric actuator 44A along and on the position correcting mechanism 36A. In other words, the gripping mechanism 38A is movable between the edge 18b and the edge 18e on the platform 18. The gripping mechanism 38A is slidable on the position correcting mechanism 36A, for example. The gripping mechanism 38A includes a groove 38Aa to grip the leg of the flying device 22 fitted in the groove 38Aa.

The gripping mechanism 38B is movable by an electric actuator 44B along and on the position correcting mechanism 36B. In other words, the gripping mechanism 38B is movable between the edge 18b and the edge 18e on the platform 18. The gripping mechanism 38B is slidable on the position correcting mechanism 36B, for example. The gripping mechanism 38B includes a groove 38Ba to grip the leg of the flying device 22 fitted in the groove 38Ba.

The electric actuator 44A is disposed on and along the position correcting mechanism 36A. The electric actuator 44A has a slider 46A that is movable by the electric actuator 44A along the position correcting mechanism 36A. The gripping mechanism 38A is disposed on the slider 46A. The gripping mechanism 38A moves with the movement of the slider 46A. A rotation shaft 48A is further disposed on and along the position correcting mechanism 36A. A bearing 48Aa is disposed on the electric actuator 44A adjacent to the edge 18b to support a first end of the rotation shaft 48A and a bearing 48Ab is disposed on the electric actuator 44A adjacent to the edge 18e to support a second end of the rotation shaft 48A. The gripping mechanism 38A is rotatable about the rotation shaft 48A by a motor, for example. The gripping mechanism 38A includes a through hole through which the rotation shaft 48A is able to pass.

The electric actuator 44B is disposed on and along the position correcting mechanism 36B. The electric actuator 44B has a slider 46B that is movable by the electric actuator 44B along the position correcting mechanism 36B. The gripping mechanism 38B is disposed on the slider 46B. The gripping mechanism 38B moves with the movement of the slider 46B. A rotation shaft 48B is further disposed on and along the position correcting mechanism 36B. A bearing 48Ba is disposed on the electric actuator 44B adjacent to the edge 18b to support a first end of the rotation shaft 48B and a bearing 48Bb is disposed on the electric actuator 44B adjacent to the edge 18e to support a second end of the rotation shaft 48B. The gripping mechanism 38B is rotatable about the rotation shaft 48B by a motor, for example. The gripping mechanism 38B includes a through hole through which the rotation shaft 48B is able to pass.

While the drawings other than FIG. 13 and FIG. 14 do not show the electric actuators 44A and 44B, the sliders 46A and 46B, the rotation shafts 48A and 48B, or the bearings 48Aa, 48Ab, 48Ba, and 48Bb, the takeoff and landing assist device 16 illustrated in the drawings other than FIG. 13 and FIG. 14 similarly includes these elements.

The electric actuators 40A, 40B, 44A, and 44B may be known actuators. The electric actuators 40A, 40B, 44A, and 44B may be a combination of components including a ball screw, a belt and pulley mechanism, a rack and pinion mechanism, a linear guide, and a motor. The electric actuator is only an example means that moves the position correcting mechanisms 36A and 36B and the gripping mechanisms 38A and 38B, and an actuator other than the electric actuator may be used to control the movement of the position correcting mechanisms 36A and 36B and the gripping mechanisms 38A and 38B.

The controller 100 controls the operation of the moving mechanisms 34A and 34B and power supply to the flying device 22, for example. The controller 100, for example, controls the movement of the position correcting mechanisms 36A and 36B and the gripping mechanisms 38A and 38B to thereby slide and move the flying device 22 landing on the takeoff and landing surface 18a to the retainer 32. The controller 100 is a computer including a processor and a memory, for example.

As illustrated in FIG. 12, the flying device 22 includes a body 49, a flight propellers 50 (only spindles thereof are shown), and a pair of legs 52A and 52B, for example.

The flying device 22 includes a battery, a motor for driving the propellers 50, various sensors, such as a gyroscope sensor, an accelerometer, a magnetic field sensor, a barometric sensor, or a Global Positioning System (GPS), for example, a flight computer for controlling the flying device 22, various drivers, and a communication interface including a transmitter and a receiver, for example.

The flight computer of the flying device 22 controls the motor to thereby control flight, such as climbing, descending, translating, for example, of the flying device 22, or controls the attitude of the flying device 22 based on information acquired by the gyroscope sensor.

The flying device 22 is controlled by a terminal device carried by a user that manipulates the flying device 22, such as a drone controller, a smartphone, or a tablet terminal, for example, or a device such as a server including a cloud server, for example. The terminal device or server transmits a manipulation instruction signal indicative of a manipulation instruction for the flying device 22 to the flying device 22 to control the flying device 22. The communication interface of the flying device 22A receives the manipulation instruction signal transmitted from the terminal device or server, and the flight computer of the flying device 22, according to the manipulation instruction signal, controls the flight or attitude of the flying device 22.

The leg 52A includes a support leg 54A and a horizontal leg 56A. The support leg 54A is a rod-shape member extending downward from the body 49. The support leg 54A has a lower end coupled to the horizontal leg 56A. The horizontal leg 56A is a rod-shape member extending horizontally, and supports the body 49 of the flying device 22 landing on the platform 18, via the support leg 54A.

The leg 52B includes a support leg 54B and a horizontal leg 56B. The support leg 54B is a rod-shape member extending downward from the body 49. The support leg 54B has a lower end coupled to the horizontal leg 56B. The horizontal leg 56B is a rod-shape member extending horizontally, and supports the body 49 of the flying device 22 landing on the platform 18, via the support leg 54B.

The horizontal legs 56A and 56B are spaced from each other in parallel or substantially in parallel to each other.

The leg 56A has a first end 56Aa that is to be inserted into the insertion hole 32a in the receiving portion 32A, and the horizontal leg 56B also has a first end 56Ba (located at the same end as the first end 56Aa) that is to be inserted into the insertion hole 32a in the receiving portion 32B. The length between the receiving portions 32A and 32B corresponds to the length between the horizontal legs 56A and 56B. The receiving portion 32A is disposed at a position corresponding to the horizontal leg 56A of the flying device 22 that has moved to the retainer 32 on the takeoff and landing surface 18a. The receiving portion 32B is disposed at a position corresponding to the horizontal leg 56B of the flying device 22 that has moved to the retainer 32 on the takeoff and landing surface 18a.

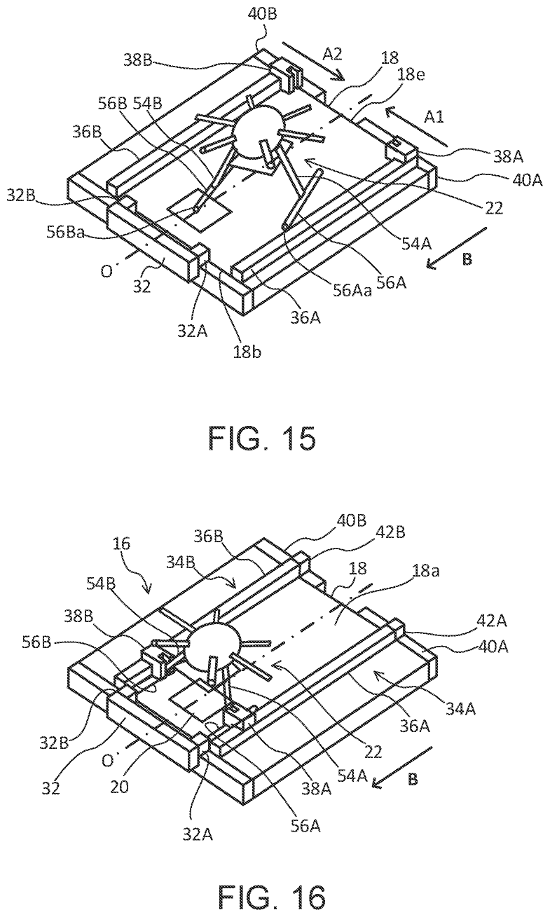

Referring now to FIG. 12, FIG. 15, and FIG. 16, operation of the takeoff and landing assist device 16 will be described. FIGS. 15 and 16 are perspective views illustrating the flying device 22 landing on the takeoff and landing surface 18a, and the takeoff and landing assist device 16.

Prior to landing of the flying device 22 on the takeoff and landing surface 18a, the position correcting mechanism 36A is disposed at the edge 18c of the platform 18 and the position correcting mechanism 36B is disposed at the edge 18d of the platform 18, as illustrated in FIG. 12. Further, the gripping mechanism 38A is disposed adjacent to the edge 18e on the position correcting mechanism 36A, and the gripping mechanism 38B is disposed adjacent to the edge 18e on the position correcting mechanism 36B.

Upon landing of the flying device 22 on the takeoff and landing surface 18a as illustrated in FIG. 15, the flying device 22, or a device such as a terminal device or a server that controls the flying device 22 transmits a signal indicative of landing of the flying device 22 on the takeoff and landing surface 18a to the controller 100. The controller 100, in response to reception of this signal, recognizes that the flying device 22 has landed on the takeoff and landing surface 18a.

In response to the landing of the flying device 22 on the takeoff and landing surface 18a, the controller 100 operates the electric actuators 40A and 40B to move the position correcting mechanisms 36A and 36B, as illustrated in FIG. 15. Specifically, the controller 100 moves the position correcting mechanism 36A from the edge 18c toward the center line O as indicated by arrow A1, and moves the position correcting mechanism 36B from the edge 18d toward the center line O as indicated by arrow A2. The controller 100 thus operates the position correcting mechanisms 36A and 36B to sandwich the horizontal legs 56A and 56B of the flying device 22 and thereby allow the flying device 22 to slide to a position along the center line O.

For example, the surface of the position correcting mechanism 36A facing the center line O comes into contact with the horizontal leg 56A, and, in this state, the position correcting mechanism 36A moves toward the center line O. This movement of the position correcting mechanism 36A allows the flying device 22 to slide on the takeoff and landing surface 18a. Similarly, the surface of the position correcting mechanism 36B facing the center line O comes into contact with the horizontal leg 56B, and in this state, the position correcting mechanism 36B moves toward the center line O. This movement of the position correcting mechanism 36B allows the flying device 22 to slide on the takeoff and landing surface 18a. The position correcting mechanisms 36A and 36B thus sandwich the horizontal legs 56A and 56B of the flying device 22 from the respective outer sides to allow the flying device 22 to slide to a position along the center line O.

As illustrated in FIG. 15, the position correcting mechanisms 36A and 36B can sandwich, from the respective outer sides, the horizontal legs 56A and 56B of the flying device 22 that has landed on the takeoff and landing surface 18a in an inclined state with respect to the edge 18b to allow the flying device 22 to face the edge 18b, that is, to allow the ends 56Aa and 56Ba of the horizontal legs 56A and 56B, respectively, to face the edge 18b.

In the illustrated example, the flying device 22 has landed on the takeoff and landing surface 18a such that the ends 56Aa and 56Ba of the horizontal legs 56A and 56B, when sandwiched by the position correcting mechanisms 36A and 36B, would face the edge 18b. In this example, the ends 56Aa and 56Ba are respectively to be inserted into the insertion holes 32a.

In another example, the flying device 22 may land on the takeoff and landing surface 18a such that ends of the horizontal legs 56A and 56B opposite the ends 56Aa and 56Ba, respectively, when sandwiched by the position correcting mechanisms 36A and 36B, would face the edge 18b. In this example, the opposite ends are to be inserted into the insertion holes 32a.

The controller 100 further operates the electric actuators 44A and 44B to move the gripping mechanisms 38A and 38B, respectively. Specifically, as illustrated in FIGS. 15 and 16, the controller 100 moves the gripping mechanisms 38A and 38B from the edge 18e toward the edge 18b, as indicated by arrow B.

The controller 100 rotates the gripping mechanism 38A about the rotation shaft 48A toward the center line O, and moves the gripping mechanism 38A, in its inclined or fallen state toward the center line O, from the edge 18e to the edge 18b. The controller 100 similarly rotates the gripping mechanism 38B about the rotation shaft 48B, and moves the gripping mechanism 38B, in its inclined or fallen state toward the center line O, from the edge 18e toward the edge 18b.

During the movement of the gripping mechanism 38A in response to the inclined gripping mechanism 38A contacting the support leg 54A of the flying device 22, the controller 100 rotates the gripping mechanism 38A about the rotation shaft 48A away from the center line O to raise the gripping mechanism 38A. The controller 100 adjusts the position of the gripping mechanism 38A by rotating the gripping mechanism 38A toward the center line O to align the position of the groove 38Aa of the gripping mechanism 38A with the position of the support leg 54A of the flying device 22. Similarly, in response to the inclined gripping mechanism 38B contacting the support leg 54B of the flying device 22, the controller 100 rotates the gripping mechanism 38B about the rotation shaft 48B away from the center line O to raise the gripping mechanism 38B. The controller 100 adjusts the position of the gripping mechanism 38B by rotating the gripping mechanism 38B toward the center line O to align the position of the groove 38Ba of the gripping mechanism 38B with the position of the support leg 54B of the flying device 22.

This allows the support leg 54A to be fitted in the groove 38Aa and gripped by the gripping mechanism 38A. Similarly, the support leg 54B is fitted in the groove 38Ba and gripped by the gripping mechanism 38B.

As illustrated in FIG. 16, the horizontal legs 56A and 56B are sandwiched by the position correcting mechanisms 36A and 36B, respectively, and the support legs 54A and 54B are gripped by the gripping mechanisms 38A and 38B, respectively, and in this state, the controller 100 moves the gripping mechanisms 38A and 38B toward the retainer 32. This allows the flying device 22 to slide to the retainer 32, allowing the end 56Aa of the horizontal leg 56A to be inserted into the insertion hole 32a of the receiving portion 32A and allowing the end 56Ba of the horizontal leg 56B to be inserted into the insertion hole 32a of the receiving portion 32B. The flying device 22 is thus secured on the platform 18.

Sandwiching the horizontal legs 56A and 56B by the position correcting mechanisms 36A and 36B, respectively, from the respective outer sides reduces a horizontal positional shift of the flying device 22.

The gripping mechanism 38A which grips and presses down the support leg 54A and the gripping mechanism 38B which grips and presses down the support leg 54B further reduce vertical oscillation of the flying device 22.

The retainer 32, the position correcting mechanisms 36A and 36B, and the gripping mechanisms 38A and 38B together constitute an example fixing device.

Operation including loading and unloading, component replacement for the flying device 22, and battery charging of the flying device 22, for example, may be performed while the flying device 22 is fixed on the platform 18. Because the flying device 22 is fixed, the flying device will not move as a result of a load applied from such operations, allowing the operator to perform the operation with respect to the flying device 22 that is in a stable state.

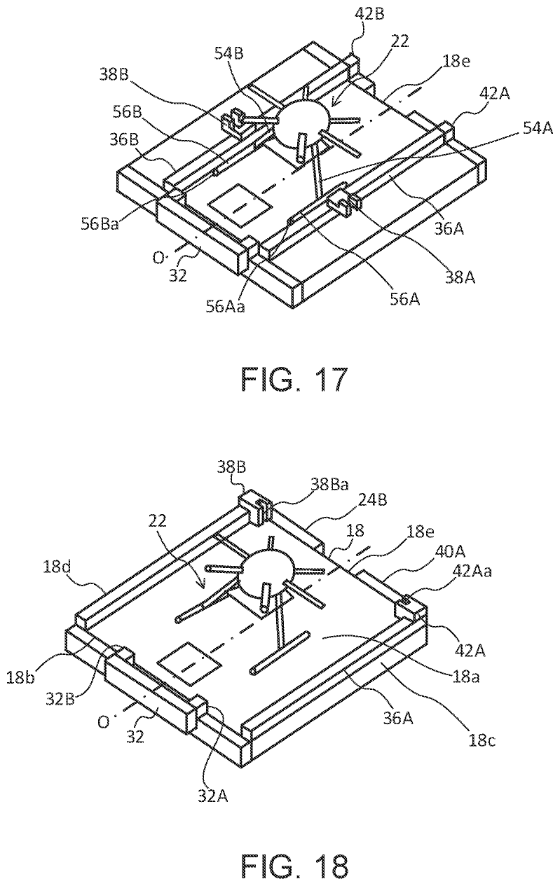

Referring now to FIG. 17 and FIG. 18, operation of the takeoff and landing assist device 16 to allow the flying device 22 to take off from the platform 18 will be described. FIGS. 17 and 18 are perspective views illustrating the takeoff and landing assist device 16 and the flying device 22.

To allow the flying device 22 to take off from the platform 18, the controller 100 operates the electric actuators 44A and 44B to move the gripping mechanisms 38A and 38B supporting the support leg 54A and the support leg 54B, respectively, from the edge 18b toward the edge 18e. For example, the controller 100 moves the flying device 22 to a center or near the center of the takeoff and landing surface 18a, as illustrated in FIG. 17. The center of takeoff and landing surface 18a refers to the center between the edge 18b and the edge 18e and also the center between the edge 18c and the edge 18d.

Then, as illustrated in FIG. 17, the controller 100 rotates the gripping mechanism 38A about the rotation shaft 48A away from the center line O to thereby release the grip of the support leg 54A with the gripping mechanism 38A. The controller 100 similarly rotates the gripping mechanism 38B about the rotation shaft 48B away from the center line O to thereby release the grip of the support leg 54B with the gripping mechanism 38B.

Subsequently, as illustrated in FIG. 18, the controller 100 operates the electric actuator 40A to move the position correcting mechanism 36A toward the edge 18c, and operates the electric actuator 40B to move the position correcting mechanism 36B toward the edge 18d. This releases support for the horizontal legs 56A and 56B with the position correcting mechanisms 36A and 36B, respectively. In this state, the flying device 22 takes off from the takeoff and landing surface 18a.

Moving the flying device 22 to the center or near the center of the takeoff and landing surface 18a to allow the flying device 22 to take off enables the flying device 22 to take off while securing a sufficient distance from the takeoff and landing assist device 16. This may reduce the effect of air current on the flying device 22 and reduce the risk of the flying device 22 impacting objects around the takeoff and landing assist device 16 immediately after takeoff, thereby enhancing takeoff safety.

1. A vehicle top structure, comprising:
a takeoff and landing assist device disposed on a top of a vehicle, the takeoff and landing assist device comprising a takeoff and landing surface where a flying device takes off and lands;
a first autonomous driving sensor disposed further forward of the vehicle on the top of the vehicle with respect to the takeoff and landing assist device, the first autonomous driving sensor configured to sense conditions ahead of the vehicle; and
a second autonomous driving sensor disposed further rearward of the vehicle on the top of the vehicle with respect to the takeoff and landing assist device, the second autonomous driving sensor configured to sense conditions behind the vehicle.

2. The vehicle top structure according to claim 1, wherein
the first autonomous driving sensor comprises a top surface and the second autonomous driving sensor comprises a top surface, and the top surface of the first autonomous driving sensor and the top surface of the second autonomous driving sensor are disposed at a lower level of the vehicle than the takeoff and landing surface.

3. The vehicle top structure according to claim 1, further comprising:
a cover disposed on the first autonomous driving sensor, the cover configured to shield the flying device when landed on the takeoff and landing surface.

4. The vehicle top structure according to claim 2, further comprising:
a cover disposed on the first autonomous driving sensor, the cover configured to shield the flying device when landed on the takeoff and landing surface.
